(19) United States
(12) Patent Application Publication
(10) Pub. No.: US 2016/0327306 A1
(43) Pub. Date: Nov. 10, 2016

(54) FLANGE CORNER CLIP

(71) Applicant: James MUTZENEEK, Calgary (CA)

(72) Inventor: James MUTZENEEK, Calgary (CA)

(21) Appl. No.: 15/146,580

(22) Filed: May 4, 2016

Related U.S. Application Data
(60) Provisional application No. 62/156,590, filed on May 4, 2015.

(51) Int. Cl. F24F 13/02; F16L 23/14

(52) U.S. Cl. CPC F24F 13/0245; F16L 23/14

(57) ABSTRACT

A corner clip apparatus and method is provided for closing open corners formed by duct flanges. The corner clip can be shipped flat and bent into the useable form at the worksite using hand tools, or pre-bent during manufacture. The corner clip comprises a planar body with first and second limbs, first and second outer flap tabs for folding below the body and engaging with duct flanges adjacent the open corner to be closed, and first and second sets of inner restraining tabs for bending over and engaging with the inner duct wall to laterally secure the corner clip to the duct. A hole can be drilled through the first and second limbs during manufacture to serve as pilot holes to drill through corresponding duct flanges and flap tabs once the corner clip is installed to allow for rivets to be installed to further secure the corner clip to the flanges.

### CROSS-RELATED APPLICATIONS

This application claims the benefits under 35 U.S.C 119(e) of U.S. Provisional Application Ser. No. 62/156,590, filed May 4, 2015, the entirety of which is incorporated fully herein by reference.

### FIELD

Embodiments described herein relate to sheet metal fabrication and more particularly to clips for closing open right angle corners of duct flanges.

### BACKGROUND

Heating and ventilating ductwork typically comprises sheet metal formed into ducting, much of which has a rectangular cross-section. At ends and connecting interfaces, the sheet metal is folded outwardly and perpendicular to the duct's longitudinal run to form four flanges, each flange extending at right angles to the duct from each side. The flanges are also generally rectangular and result in open corners, typically voids of rectangular dimensions.

At duct ends, as a result of rotating a cut in a planar sheet 90 degrees, the resulting corners remain open and, where a seal is required, such as at a fire damper sleeve or roof top units or other such surface penetration, the corners must be closed such as with a corner bracket or filler. One methodology to close rectangular duct flange corners is to use transverse duct corner connectors (TDC) or connectors for transverse duct flanges (TDF). These are L-shaped corner pieces that fill the corner and extend to overlap the flanges extending either side of the corner. TDCs are typically crimped to the adjacent flanges using a crimping tool. TDF can be crimped or screwed to the adjacent flanges. At the corner, there is usually a bolt hole for flange-to-flange duct connections.

Popular TDC/TDF corners are typically heavy gauge stamped components, requiring a hand or pneumatically operated crimping tool, and the installer is often encouraged to preassemble such ducts to the greatest extent possible to avoid on-site crimping. Such preassembly increases shipping bulk, the duct consuming 3-D space rather than 2-D planar space, and often requiring crane use for rooftop installations.

Other coupling devices exist, such as that disclosed in U.S. Pat. No. 4,461,499, which teaches an L-shaped cover member to be installed on overlapping coupling members for joining together sections of ducting, comprising a plurality of uni-directional sharp projections for biting into the metal flanges as they are installed, resisting removal.

There remains a need for a device that minimizes the need for specialty tools and skill and minimizes bulk.

### SUMMARY

Herein, a corner clip is provided that can be easily field installed to a rectangular duct end without specialized tools. As the corner clip can be shipped flat, and an installer can form and install the corners at the worksite as opposed to pre-assembling, a variety of advantages are realized including improved duct integrity and manufacture, more efficient shipping, and a reduction in the number and weight of tools required.

The corner clip can be field installed using only conventional hand tools such as seamers or hammers, adds strength to the connector end of ducts without specialized tools, and can be installed by one person.

Hand seamers need only the installer's own hand grip for bending, folding, flattening, and straightening sheet metal edges. A seamer can be used to fold portions of a clip onsite. A sheet metal or tinner's hammer can be used to retain clips to the duct. The clips can be provided flat and folded on site, or provided with a portion pre-folded and requiring only a hammer to install the final tabs to retain the clip to duct flanges.

The clips complete all flanges to close the orthogonal and open corners of flanges of a duct. Thus, the closing of open corners can meet requirements imposed on the finishing of fire damper ducts and sleeves and increases the efficiency of ducting of rooftop units. Closing the corner with clips also significantly strengthens the duct, and installation takes a fraction of the time currently required for the spot welding, or crimping, of conventional L-shaped transverse duct connectors (TDC). When welding is required, the clips securely and firmly hold the duct square while welding.

A large number of clips can be shipped in their flat state with minimal room and lower shipping costs. Similarly, the duct work can be shipped to the site and safely manhandled to the installation location, particularly elevator or roof locations, in an unassembled state. There is a reduced need for cranes for lifting bulky, pre-assembled duct work. Unassembled product also requires less pre-shipping floor space in shops.

### BRIEF DESCRIPTION OF THE DRAWINGS

FIG. 1A is a perspective view of a rectangular duct having an end flange fit with clips to close 3 of 4 open corners and the fourth clip (with the two flap tabs shown in stippled lines) in the process of being installed onto the final open corner;

FIG. 1B is a small partial view of one flange bent to 90 degrees from a sheet metal duct blank, and another flange not yet bent;

FIG. 2A is a plan rolled out flat view of a corner clip according to an embodiment having one flap tab per limb, prior to breaking or folding into the useable form;

FIG. 2B is a plan rolled out flat view of a corner clip according to an embodiment and having two flap tabs per limb, prior to breaking or folding into the useable form, and having a pilot hole on each limb;

FIG. 2C is a plan rolled out flat view of a corner clip according to an embodiment and having two spaced flap tabs per limb, prior to breaking or folding into the useable form;

FIG. 2D is a plan rolled out flat view of an alternative embodiment of a corner clip having a tapered flap tab per limb, prior to breaking or folding into the useable form, and shown folded under in dotted lines;

FIG. 2E is a plan rolled out flat view of an alternative embodiment of a corner clip having a tapered flap tab per limb, prior to breaking or folding into the useable form, and shown folded under in dotted lines;

FIG. 2F is a partial perspective view of a corner of a duct end fit with a clip, each of the adjacent flanges having a different height and the respective flange-receiving pocket of the clip having a different depth;

FIGS. 3A, 3B and 3C are top, bottom and side views of a folded clip respectively, one underside flap tab not fully folded for better distinguishing of the two distinct flap tabs in the side view;

FIGS. 4A, 4B and 4C are top, bottom and side views of a folded clip respectively according to FIGS. 3A-3C illustrating a less substantial flap tab;

FIG. 5A is a partial, side cross-sectional view of one corner of the duct from within the duct and a manual bending of one of two or more retainer tabs into the duct interior to retain the clip to the flanges; and

FIG. 5B is a partial, side cross-sectional view of one corner of the duct from within the duct with an optional rivet securing the corner to the duct flange.

### DETAILED DESCRIPTION

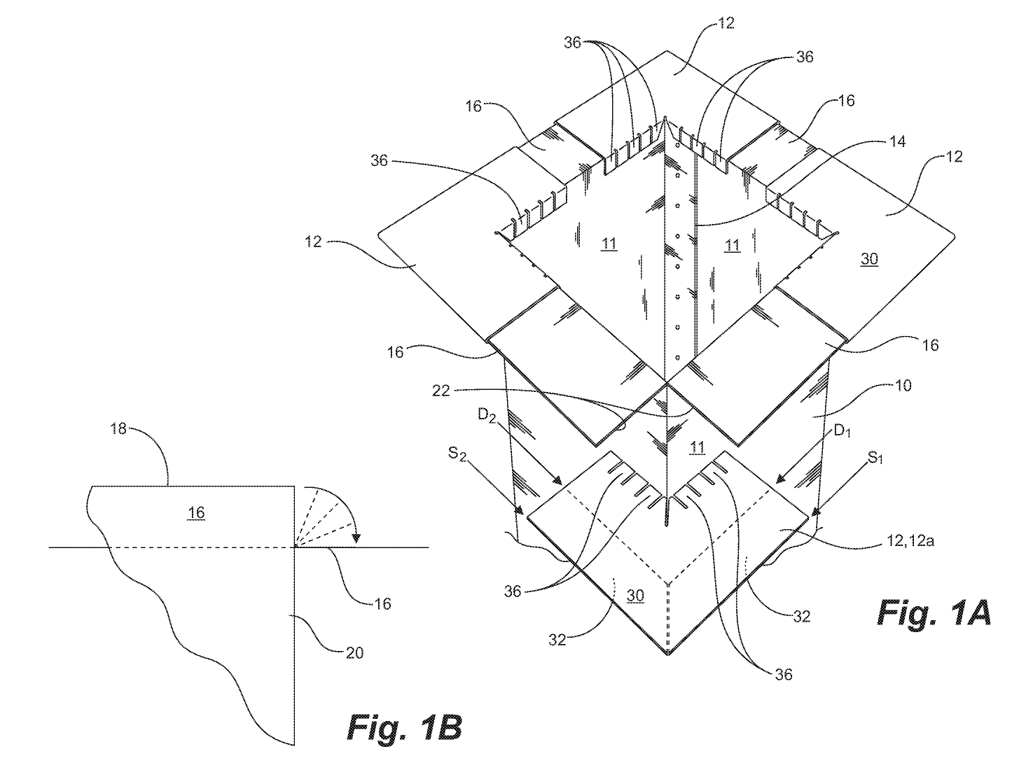

With reference to FIG. 1A, a rectangular duct 10 is fit with embodiments of corner clips 12 according to one embodiment of the invention. The duct 10 is generally rectangular and spot-welded along one seam 14. As shown also in FIG. 1B, four flanges 16,16,16,16 (of which two are shown) are bent at right angles from a duct end 18 of the sheet metal blank 20 duct end. The duct flanges extend perpendicularly a height from respective duct walls. Each of adjacent flanges 16 can extend the same or different heights. In FIG. 1B, one longitudinally-extending flange 16 is not yet bent, remaining longitudinally projecting, and one other flange 16 is shown being bent over at right angles. As shown in FIG. 1A, when flanges 16 are bent out of the plane of the walls 11 of the flat sheet metal, an orthogonal open corner 22 results at each pair of adjacent bent flanges 16,16 and thus at each of four corners. Three clips 12 are shown installed and one clip 12a in the foreground is poised or arranged to slide over two adjacent flanges 16 to span, close, or otherwise complete and close the fourth and last open corner 22.

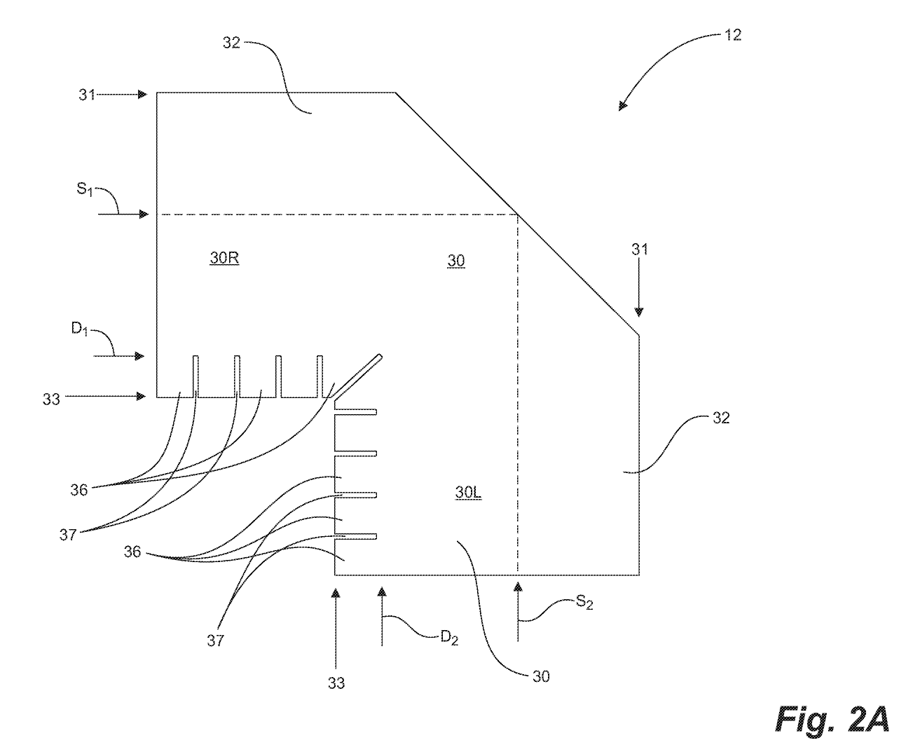

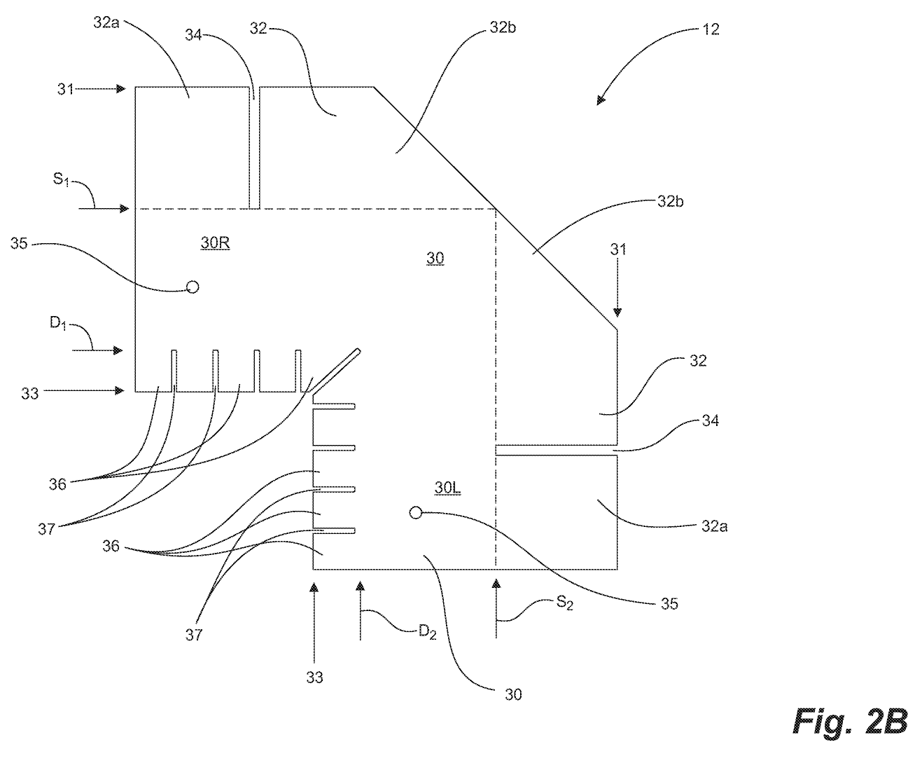

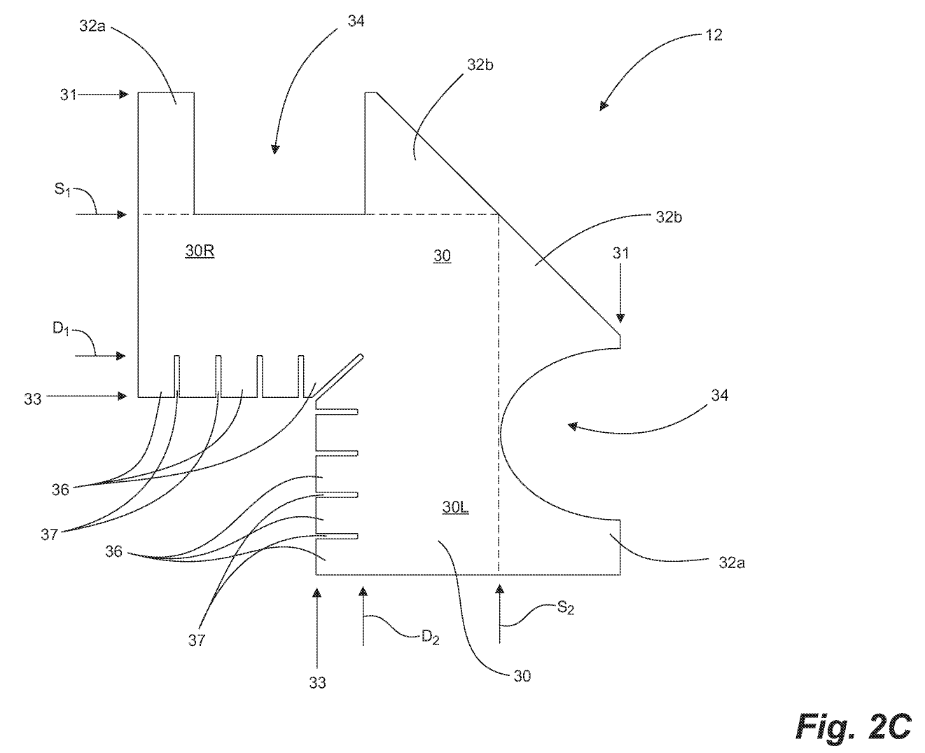

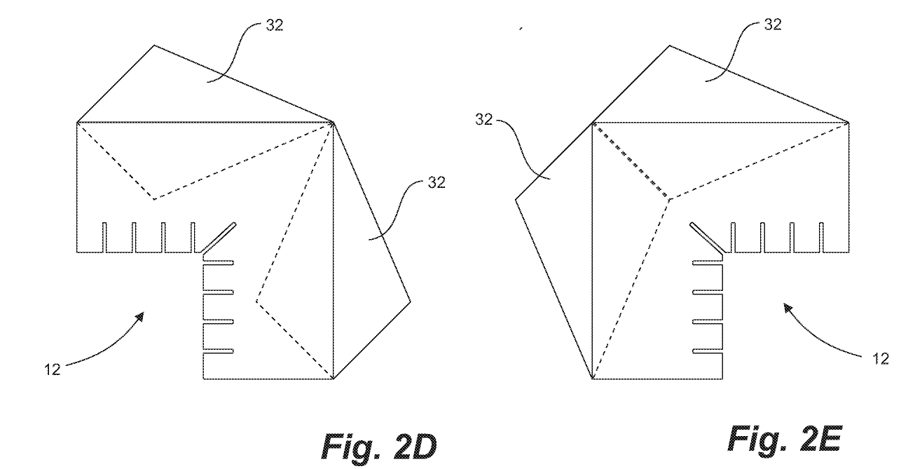

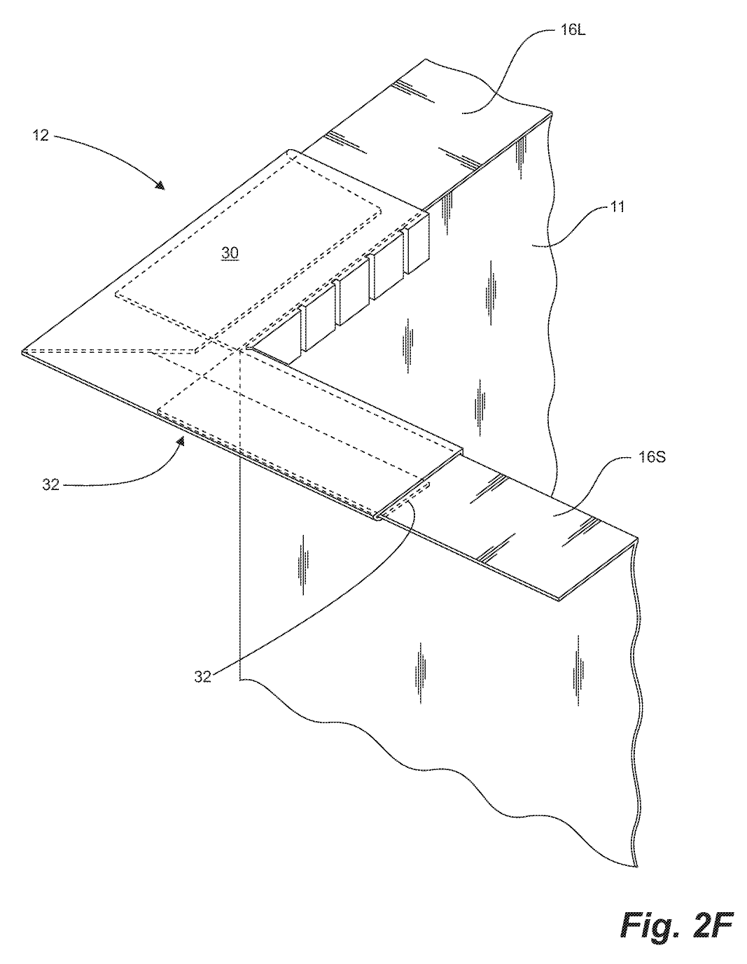

Turning to FIG. 2A, each clip 12 is formed from a blank of planar sheet metal. The blank can be embossed, scribed, or otherwise marked to indicate bend lines. Alternatively, using a for-the-purpose bending tool or a shop jig, the required folding depth can be achieved without a need for marking.

The blank has a generally L-shaped body 30, having two limbs 30L,30R, the limbs have perpendicular outer edges 31,31 outer edges and perpendicular inner edges 33,33. First and second outer flap tabs 32,32, comprising one or more tabs, extend outwardly from first and second side fold lines S1,S2. In this embodiment, the fold lines S1,S2 extend generally parallel to each limb's outer edges 31,31. One tab for each limb is shown, easily formed along the entirely of the limb with a seamer in the onsite or pre-formed at a manufacturing facility. As shown in FIGS. 2B and 2C, each flap tab 32 can also be formed as two or more flap tabs, whether adjacent, spaced by a separated slot 34 or larger discontinuous slot 34. As shown in FIG. 2C, the flap tabs 32 need not be orthogonal or have straight edges, but may be curved or otherwise irregularly shaped. Such smaller flap tabs 32, having a shorter “hinge”, are more readily bent with hand tools onsite. With reference to FIGS. 2D and 2E, the outside edges of the flap tabs 32 also need not be parallel to the side fold lines S1,S2. As shown, the tabs need only to form a flap or flaps that can be folded under the body.

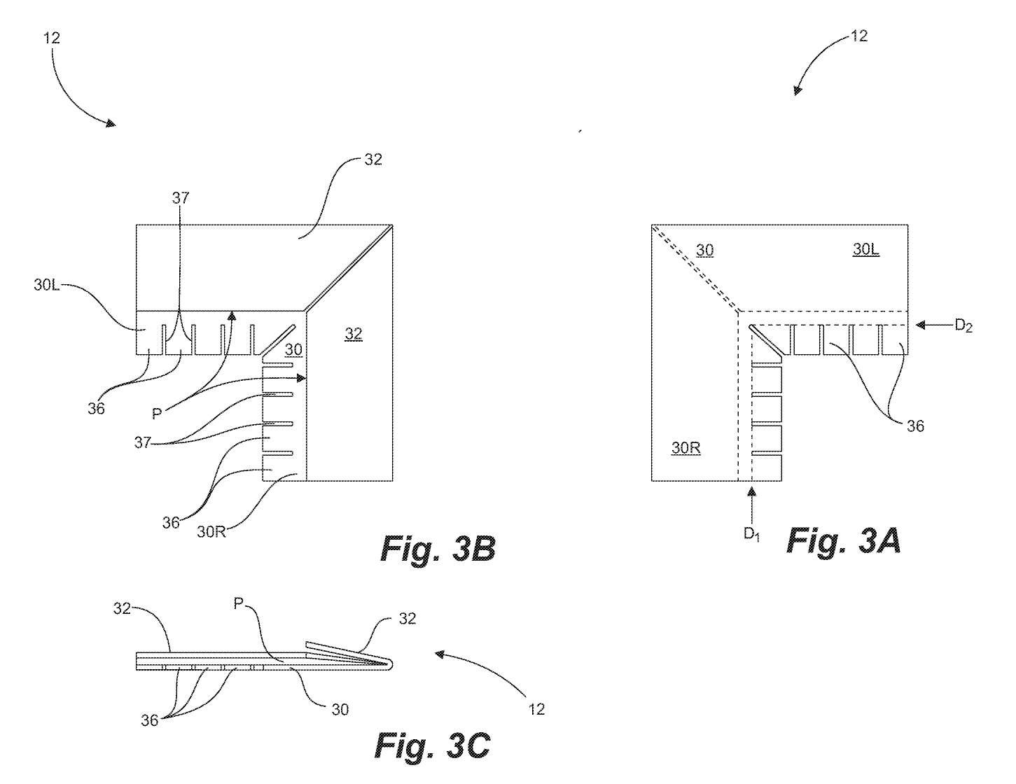

With reference to FIGS. 3B and 3C, the flap tabs 32 are folded along the side fold lines S1,S2 and under the body 30. The fold lines S1, S2 are at right angles to each other. As shown in FIG. 3A, the portion of the body 30 remaining unfolded forms a planar connector that is available to close across an open corner when assembled thereto. The flap tabs 32 form a flange-receiving pocket P for sandwiching a flange 16 between the body 30 and flap tab 32 to retain the clip thereto and fixed longitudinally to the duct.

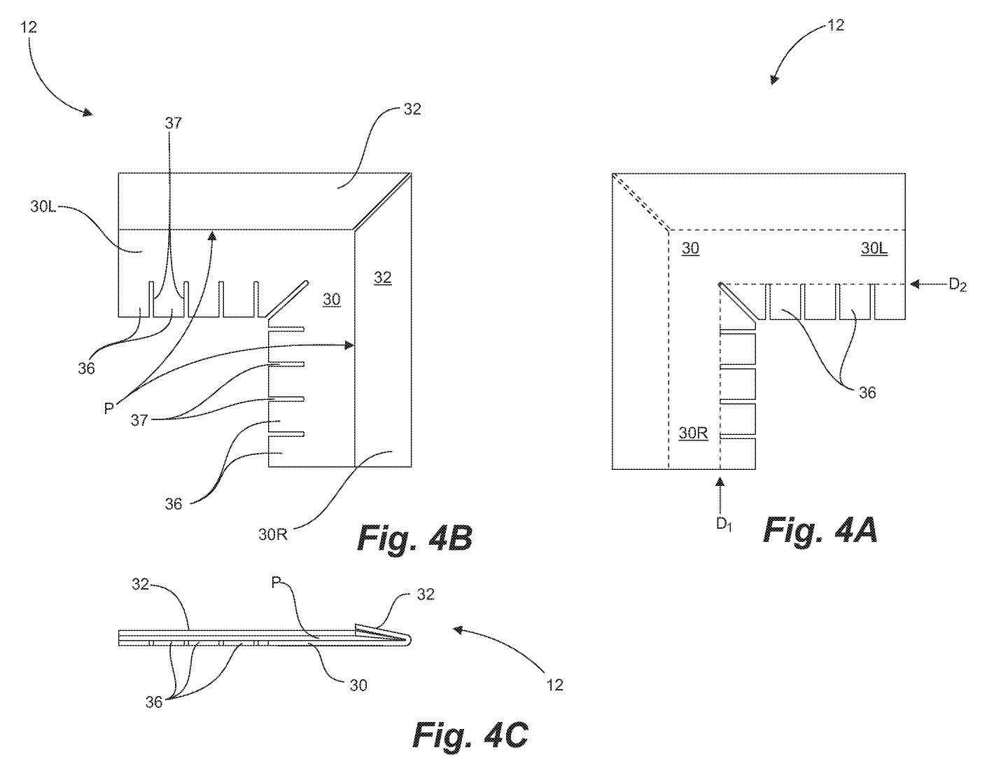

With reference to FIGS. 4A, 4B and 4C, the flap tab 32 need not be very substantial. As long as the flap tab 32, even shorter in extent than the flange 16, still retains the clip longitudinally to its respective flange 16, then it is sufficiently large to retain the clip 12 to the duct 11. In order to function, the body of the clip continues to bridge the open corner 22, regardless of the extent of the flap tab 32.

Each clip 12 also has one or more inner duct restraining tabs 36,36 . . . . Each tab 36 is formed between slots 37,37. The tabs 36, 36 . . . are typically spaced equally apart. Each slot 37 extends inwardly into the clip from the clip periphery or inner edge 33 to a tab depth, such as that indicated by duct bend lines D1,D2, that correspond with the duct's inner walls 11 when installed. Duct bend lines D1,D2 are parallel to side fold lines S1,S2. Thus, each clip has at least two restraining tabs, at least one per duct bend line D1,D2. The net distance between bend lines D1,D2 and S1,S2 respectively determine the depth of pocket P, being deep enough to receive flange 16. As a result, the length of tabs 36 extend to and beyond the respective duct wall 11. As shown in FIG. 2F, if the adjacent flanges are of differing heights, the clip body 30 and side fold lines S1,S2 are correspondingly sized and spaced respectively to accommodate.

The net distance between the duct bend lines D1,D2 and S1,S2 is about equal to the height of the flange 16. The distance may also be less than the height of the flange 16, for example either due to using an incorrectly-sized corner clip 12 or due to improper installation, with the result that the slots 37 may extend beyond the duct's inner wall 11 and overlap the flange 16. Such a configuration will not compromise the function of the corner clip 12, so long as the length of the restraining tabs 36 is sufficient to engage the inner duct wall 11 and prevent lateral movement of the corner clip 12. In this configuration, the corner clip will still adequately seal the open corner 22 between the duct flanges 16,16, as duct sealer is typically applied to fill in gaps between the flange 16 and the clip 12 to provide a complete seal. The corner clip 12 may also be usable if the distance between bend lines D1,D2 and S1,S2 is greater than the height of the flange 16. However, such an arrangement would result in duct bend lines D1,D2 overhanging the inner duct wall 11 and providing a more difficult bend and possible a less precise engagement between the restraining tabs 36 and the inner duct wall 11. The clip 12 can be shipped to a worksite flat/un-formed as shown in FIGS. 2A to 2C, and the flap tabs 32,32 can therefore be formed on site using, for example, a hand seamer. Alternatively, as shown in FIG. 3A, the flap tabs of clips 32 can be folded in advance, such as during manufacture, and shipped pre-folded in large numbers in pails or other convenient packaging, ready for use as shown in FIGS. 3A-3C.

With reference to FIGS. 1A and 2F, the clip 12 is slid onto an open corner 22 with the pocket P, formed by the body 30 and flap tabs 32. The clip can be installed diagonally for engaging and straddling the adjacent flanges 16,16 simultaneously, or sequentially onto one flange 16 and then the other. For installation, the restraining tabs 36 remain planar with the body 30.

The flange receiving pockets P engage the duct flange 16, and the clip is slipped or tapped onto the corner until the flanges 16,16 approximately or generally bottom out in the pockets at or adjacent the clip's sides fold lines S1,S2. The spacing of the side fold lines S1,S2 and duct bend lines D1,D2 are sufficient that the restraining tabs 36 at least partially overhang their respective inner duct wall 11.

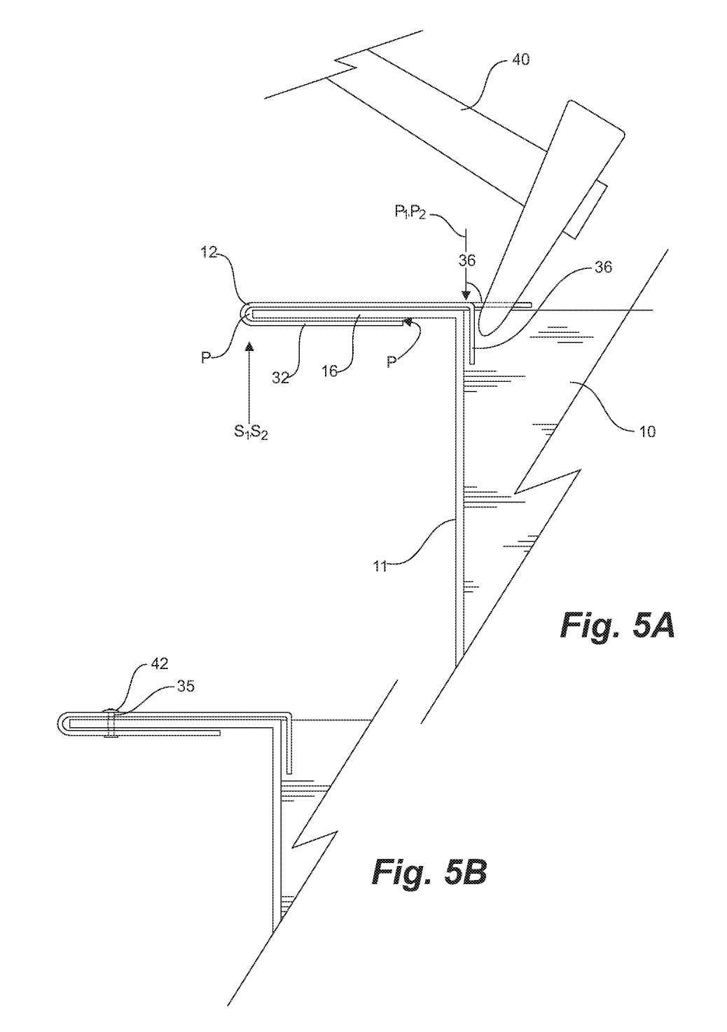

As shown in FIG. 5A, to retain the clip 12 to the corner, a tool, such as a hammer 40 is used to bend each restraining tab 36 over the edge of the wall/flange interface. Each tab 36 is bent at about 90 degrees, locking the each pocket P over its respective flange 16, securing to the clip to the corner 22. A spacing between the side fold lines and duct fold lines being at least the height of their respective flanges. While one restraining tab 36 per limb 30L,30R would serve to retain the clip's respective limb to the flange 16, having two or more restraining tabs 36 provide a cleaner installation. A plurality of tabs 36,36 . . . with multiple slots 37,37,37 . . . result in smaller tabs that are easier to bend. As illustrated in FIGS. 3A to 3C, five or six restraining tabs 36, with corresponding slots 37, are spaced along and extend perpendicularly from each duct bend line D1,D2. Having a plurality of tabs 36,36 . . . confers the added advantage of better engaging the clip 12 with the inside duct wall 11 where the duct is welded together along a seam 14 resulting in a variation in wall thickness.

In another embodiment, and with reference to FIGS. 2B and 5B, a pilot hole 35 can be drilled into each limb 30L,30R. Once the clip 12 is installed over its respective corner 22, the installer also drills through the flange 16 and flap tab 32 using the pilot hole 35 as a guide. A rivet 42 can then be installed through the holes in each limb 30L,30R and its respective flange 16, and flap tab 32 to further secure the clip 12 to its corresponding flanges 16,16. If no pilot hole is pre-drilled during manufacture, the installer can drill through all three layers at the worksite.

The process is repeated for each of the corners 22,22,22,22. The duct 11 can be installed in to the building structure penetration with each corner 22 now continuous with the remainder of the duct flanges and forming a continuous structure and barrier.

The clips 12 can be manufactured for flanges having a variety of different sizes, typically flanges having a length or height of ½″ to 4″ long, but any size can be provided with a corresponding depth of pocket P. Further, the sheet metal for various clips can be provided in a variety of gauges.

1. A corner clip for closing an open orthogonal corner of adjacent first and second duct flanges extending perpendicularly a height from respective duct walls, comprising:
a planar L-shaped body of sheet metal having a first limb and a second limb at right angles to one another, the respective limbs having first and second outside edges at right-angles, and first and second inside edges at right-angle;
at least a first flap tab formed along the first outside edge and foldable along a first side fold line, and at least a second flap tab along the second outside edge and foldable along a second side fold line, the first and second side fold lines being at right angles to each other, each of the first and second flaps foldable under the body for forming first and second flange-receiving pockets; and
a first and second set of restraining tabs formed along each of the first and second inside edges, bendable along first and second duct lines each spaced parallel from the first and second side fold lines respectively, wherein
the spacing between side fold lines and duct fold lines being about equal to the respective heights of the adjacent flanges for receiving each flange within its respective pocket therein and positioning the restraining tabs for bending over the duct wall.

2. The corner clip of claim 1, wherein the first outside edge is parallel to the first side fold line.

3. The corner clip of claim 1, wherein the second outside edge is parallel to the second side fold line.

4. The corner clip of claim 1, wherein each of the first and second sets of restraining tabs comprise two or more restraining tabs.

5. The corner clip of claim 4 wherein the two or more restraining tabs are spaced equally apart.

6. The corner clip of claim 1 wherein the at least a first flap tab is one first flap tab.

7. The corner clip of claim 1 wherein the at least a first flap tab is two or more first flap tabs.

8. The corner clip of claim 1 wherein the at least a second flap tab is one second flap tab.

9. The corner clip of claim 1 wherein the at least a second flap tab is two or more first flap tabs.

10. A method for closing orthogonal open corners of adjacent duct flanges at a duct end, each flange extending perpendicularly from a respective duct wall, the method comprising:
providing an L-shaped corner clip, the clip having a planar body having a first limb and a second limb at right angles;
folding an outside edge of the first limb under the body along a first fold line to form a first flange-receiving pocket;
folding an outside edge of the second limb under the body along a second fold line to form a second flange-receiving pocket, the first and second fold lines at right angles to each other;
sliding the first flange-receiving pocket over a first of the adjacent flanges to close the open corner with the body;
sliding the second flange-receiving pocket over a second of the adjacent flanges;
overhanging an inside edge of the first limb and an inside edge of the second limb over their respective duct walls; and
bending the inside edges over the duct wall to retain the body of the clip to the duct.

11. The method of claim 10, further comprising shipping a plurality of clips to a worksite, wherein the folding of the outside edges of the first and second limbs under the body is performed prior to shipping to the worksite.

12. The method of claim 10, further comprising shipping a plurality of clips to a worksite, wherein the first and second flange-receiving pockets are folded after shipping to the worksite.

13. The method of claim 12 wherein the first and second outside edges are folded using a hand seamer.

14. The method of claim 10, further comprising folding the inside edges of the first and second limbs with a hammer.

15. The method of claim 14, wherein each of the inside edges of the first and second limbs are a plurality of restraining tabs, further comprising folding each restraining tab with the hammer.
